(19) United States
(12) Patent Application Publication
(10) Pub. No.: US 2024/0009499 A1
(43) Pub. Date: Jan. 11, 2024

(54) DEVICE FOR FORCING THE OPERATION OF A TEMPERATURE SENSITIVE FIRE EXTINGUISHER

(71) Applicant: WHISUNG CORP.,LTD, Hwaseong-si (KR)

(72) Inventor: Kil Sik MIN, Suwon-si (KR)

(21) Appl. No.: 18/071,772

(22) Filed: Nov. 30, 2022

(30) Foreign Application Priority Data
Jul. 8, 2022 (KR) 10-2022-0084291

(51) Int. Cl. A62C 37/42; A62C 37/48

(52) U.S. Cl. CPC A62C 37/42; A62C 37/48

(57) ABSTRACT

A device for forcing the operation of a temperature sensitive fire extinguisher includes an input unit configured to receive data from any one of a video camera, a thermal imaging camera, an electromagnetic wave sensor, a three-axis acceleration sensor, a CO gas sensor, a UV sensor, and an ultrasonic sensor. The device further includes a processing unit configured to calculate a fire occurrence sign based on the data; and an output unit configured to heat a temperature sensing unit of a temperature sensitive fire extinguisher by operating a trigger when the processing unit determines that there is a sign of fire.

### TECHNICAL FIELD

Embodiments of the invention relates to a device for forcing the operation of a temperature sensitive fire extinguisher that may allow forcible operation of a temperature sensitive fire extinguisher that operates by sensing temperature.

### BACKGROUND

In general, a fire extinguisher may be used to extinguish an initial fire. The fire extinguisher is installed in a device or place where a fire is expected, and the fire extinguisher automatically operates to extinguish the initial fire when a fire is suspected.

According to the type of fire extinguisher, it is known as a diffusion type fire extinguisher that operates automatically by sensing temperature.

The conventionally known diffusion fire extinguishers are fixed at the reaction temperature value set at the time of product installation or set by the fire extinguisher manufacturer.

The diffusion fire extinguishers are installed in specific facilities or places such as fire hazard zones, switchboards, and computer servers, and in most cases, after installation, the reaction temperature value is not modified until the expiration date of the diffusion fire extinguisher, for example, until it is replaced.

According to the manufacturer, the diffusion fire extinguishers are generally set at 160° C., and when a consumer requests a specific reaction temperature value, it can be manufactured by adjusting the reaction temperature value. However, as described above, once the diffusion fire extinguisher is installed, its reaction temperature value does not change until it is replaced, and the manager may pay little attention to it. Once the diffusion fire extinguisher is installed, the manager may carelessly assume that even if a fire occurs, the fire will not spread if the diffusion fire extinguisher is activated.

However, a fire may occur suddenly at a place that the manager did not expect, and it is practically impossible to install the diffusion fire extinguisher in all places and all components to react to the fire.

In addition, when the fire occurs, the temperature rises and the flame may spread to the surroundings, but the diffusion fire extinguisher does not operate until the ambient temperature reaches the reaction temperature value.

That is, the conventionally known diffusion fire extinguisher may react after the flame has already spread widely, and in this case, there may be a problem in that the initial fire suppression cannot be achieved.

For example, the diffusion fire extinguisher described above has a reaction temperature of 160° C., but when a fire occurs at a distance from the diffusion fire extinguisher and the ambient temperature of the diffusion fire extinguisher reaches the reaction temperature, there is a problem that the initial fire cannot be extinguished because the flame has already greatly expanded.

If you check by playing the video of non-patent document 1, it can be seen that in the diffusion fire extinguisher experiment video, the extinguishing time takes about 30 seconds from starting the fire until the fire is extinguished, and it can be seen that the extinguishing time takes 30 seconds at the shortest and 1 minute at the longest even if you look for an extinguishing experiment video of other fire extinguishers on the video site. Since this extinguishing time is too long, there is a possibility that the fire will spread to a greater extent in the actual fire site.

That is, although the conventionally known diffusion extinguisher is installed to extinguish the initial fire, there is a problem in that fire occurs at any fire point and fire suppression is not attempted until the ambient temperature of the temperature sensor of the diffusion extinguisher reaches the reaction temperature value. Therefore, a solution is needed.

In addition, in order to prevent fire in industrial facilities, the diffusion fire extinguisher can be installed inside the cabinet or inside the device. But the temperature may rise abnormally in the absence of a flame, and even if a fire is expected due to an abnormal temperature rise in certain components, the diffusion fire extinguisher may not work immediately, for example within a second or two seconds.

In addition, there is a problem in that the dangerous temperature for each component of the industrial facilities may be different for each, and it is impossible to determine whether the temperature rise is a normal temperature or an abnormal temperature, so that it is not possible to react when a fire actually occurs.

On the other hand, since the ignition point temperature of each component may be different even within the facility of one observation target, for example, the ignition point temperature of the first component may be the normal heating temperature of the other second component. Therefore, sensing the temperature of the possibility of ignition from the temperature in the overall atmosphere of the facility to be observed may not be appropriate for fire prevention, and in some cases, there may be a problem presumed to be a fire even with normal heat, so more sophisticated fire prevention measures are needed.

### DOCUMENTS OF RELATED ART

### Patent Document

(Patent document 1) KR 10-2060568 B1

(Patent document 2) KR 10-1440492 B1

(Patent document 3) KR 10-2346594 B1

(Patent document 4) KR 10-2339920 B1

(Patent document 5) KR 20-0403498 Y1

(Non-patent document 1) YouTube video: AFC sticker Innocean Factory www.gfin.co.kr

Shortcut address: https://youtu.be/FvUBwNZgULw?t=63

Posted on: 2018.06.21

### SUMMARY

Embodiments of the invention are to solve the above problems, and an object is to provide a device for forcing the operation of a temperature sensitive fire extinguisher that may allow forcible operation of a temperature sensitive fire extinguisher when there is a sign of fire or a fire is estimated to occur even if the ambient temperature of the temperature sensing unit of the diffusion fire extinguisher does not reach the reaction temperature value, or when the temperature of the object to be observed reaches a reaction temperature value set by the user even if there is no flame in a specific facility or component of the facility.

In addition, another object is to provide a device for forcing the operation of a temperature sensitive fire extinguisher that may allow a more sophisticated diagnosis of the possibility of a fire by enabling precise recognition of whether the heating temperature is in a normal range or an abnormally high temperature in a specific component of the facility to be observed.

The device for forcing the operation of the temperature sensitive fire extinguisher according to the embodiment of the invention for achieving the above technical problem comprises an input unit 110 for receiving data from any one of a video camera 21, a thermal imaging camera 22, an electromagnetic wave sensor 31, a three-axis acceleration sensor 32, a CO gas sensor 33, a UV sensor 34, and an ultrasonic sensor 35; a processing unit 120 for calculating a fire occurrence sign based on the data; and an output unit 130 for heating a temperature sensing unit 52 of a temperature sensitive fire extinguisher 50 by operating a trigger 40 when the processing unit 120 determines that there is a sign of fire.

In addition, in the device for forcing the operation of the temperature sensitive fire extinguisher according to the embodiment of the invention, the output unit 130 further includes a communication port 36 to communicate with a remote control unit 60, and the remote control unit 60 may be configured to forcibly operate the trigger 40 by forcibly inputting an operation signal to the processing unit 120 to operate the trigger 40.

In addition, the device for forcing the operation of the temperature sensitive fire extinguisher according to the embodiment of the invention may be configured to include a body box 10 in which any one or a plurality of selected ones of an electromagnetic wave sensor 31, a three-axis acceleration sensor 32, a CO gas sensor 33, a UV sensor 34, and an ultrasonic sensor 35 are installed; and a swing body 20 installed in the body box 10 and adjusted and fixed to face the object to be observed, and installed with a video camera 21 and a thermal imaging camera 22 so that the video camera 21 and the thermal imaging camera 22 photograph the object.

In addition, the device for forcing the operation of the temperature sensitive fire extinguisher according to the embodiment of the invention may be configured to further include a light 23 installed on one side of the video camera 21 or the thermal imaging camera 22 to illuminate the object to be observed to increase the video image quality.

Other specific details of embodiments are included in the detailed description and drawings.

In the device for forcing the operation of the temperature sensitive fire extinguisher according to the embodiment of the invention, the reaction temperature value may be set arbitrarily according to the user's will, the possibility of fire from various sensors may be diagnosed, and the temperature sensitive fire extinguisher may be forcibly operated immediately when there is a fire sign without delaying time, thereby actively coping with the initial fire, and having the effect of more effectively preventing the flame from spreading.

### BRIEF DESCRIPTION OF DRAWINGS

FIG. 1 is a view for illustrating a device for forcing the operation of a temperature sensitive fire extinguisher according to an embodiment of the invention.

FIG. 2 is an exploded view for illustrating the main configuration of a device for forcing the operation of a temperature sensitive fire extinguisher according to an embodiment of the invention.

FIG. 3 is a plan view illustrating a device for forcing the operation of a temperature sensitive fire extinguisher according to an embodiment of the invention.

FIG. 4 is a schematic diagram for illustrating the operation of a device for forcing the operation of a temperature sensitive fire extinguisher according to an embodiment of the invention.

### DETAILED DESCRIPTION OF EXEMPLARY EMBODIMENTS

Advantages and features of the invention, and methods for achieving them will become apparent with reference to the embodiments described below in detail in conjunction with the accompanying drawings.

Hereinafter, the embodiments of the invention will be described in detail with reference to the accompanying drawings. It will be understood that the embodiments described below are illustratively shown to help the understanding of the invention, and that the invention may be implemented with various modifications different from the embodiments described herein. However, when it is determined that a detailed description of a known function or component related to the invention may unnecessarily obscure the gist of the invention, the detailed description and specific illustration thereof will be omitted. In addition, the accompanying drawings may not be drawn to scale, but the size of some components may be exaggerated to help the understanding of the invention.

On the other hand, the terms to be described later are terms set in consideration of functions in the invention, which may vary depending on the intention or custom of the manufacturer, so the definition should be made based on the content throughout this specification.

Like reference numerals refer to like elements throughout.

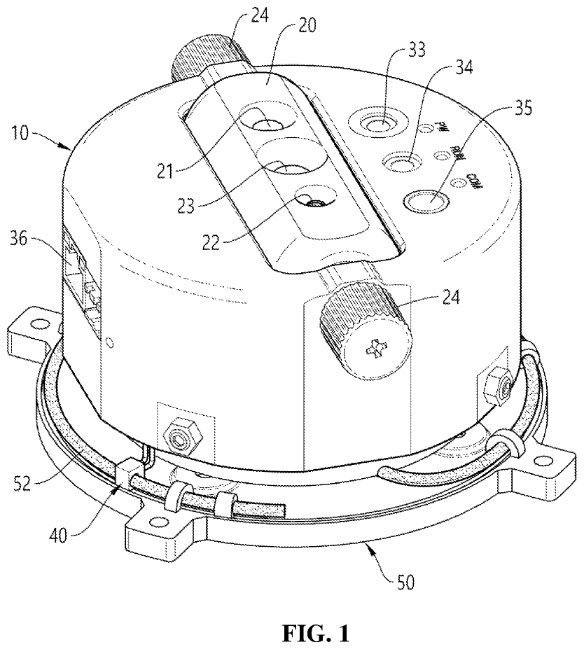

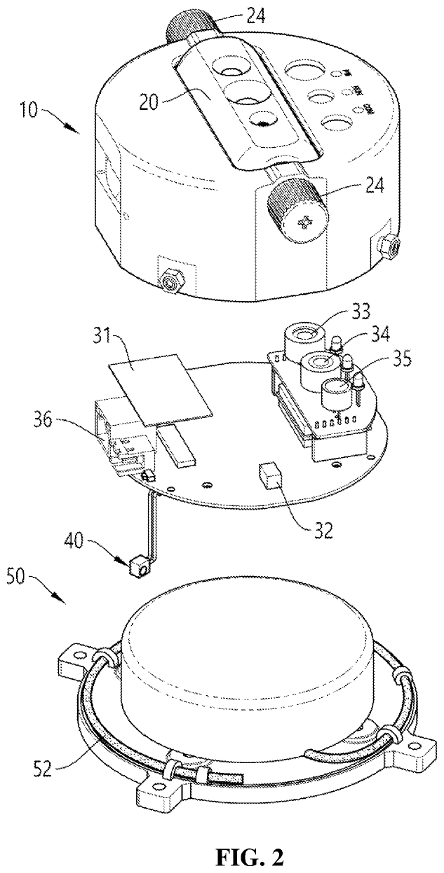

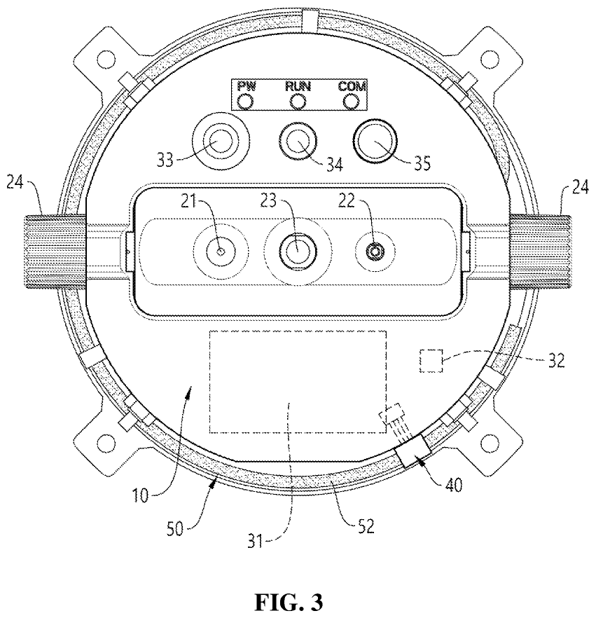

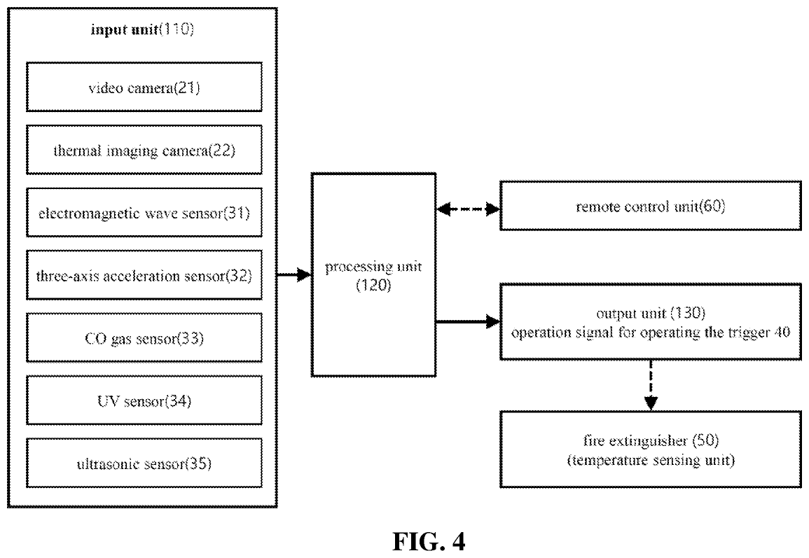

Hereinafter, a device for forcing the operation of a temperature sensitive fire extinguisher according to an embodiment of the invention will be described with reference to FIGS. 1 to 4. FIG. 1 is a view for illustrating the device for forcing the operation of the temperature sensitive fire extinguisher according to an embodiment of the invention. FIG. 2 is an exploded view for illustrating the main configuration of a device for forcing the operation of a temperature sensitive fire extinguisher according to the embodiment of the invention. FIG. 3 is a plan view illustrating the device for forcing an operation of a temperature sensitive fire extinguisher according to the embodiment of the invention. FIG. 4 is a schematic diagram for illustrating the operation of a device for forcing the operation of a temperature sensitive fire extinguisher according to the embodiment of the invention.

The device for forcing the operation of the temperature sensitive fire extinguisher according to the embodiment of the invention may be configured to include an input unit 110, a processing unit 120, and an output unit 130.

The input unit 110 receives data from any one of a video camera 21, a thermal imaging camera 22, an electromagnetic wave sensor 31, a three-axis acceleration sensor 32, a CO gas sensor 33, a UV sensor 34, and an ultrasonic sensor 35.

The video camera 21 may photograph an object to be observed, and the captured video image may be provided to the processing unit 120, and the processing unit 120 may determine whether a flame has occurred based on the video image.

The thermal imaging camera 22 may photograph an object to be observed, and the captured thermal image may be provided to the processing unit 120, and the processing unit 120 may determine whether an abnormal temperature has occurred based on the thermal image. For example, each component to be observed generates appropriate heat, and if a hot temperature is generated higher than the allowable temperature, it may be considered as a fire hazard.

The electromagnetic wave sensor 31 detects an electric or magnetic field generated by the component to be observed, and when the frequency is outside the allowable frequency range, it may be regarded as an abnormality.

The electromagnetic wave sensor 31 detects an electromagnetic wave generated from an arc or corona in the component to be observed, and if the intensity of the electromagnetic wave is high enough to be outside the allowable range, it may be regarded as an abnormality.

The three-axis acceleration sensor 32 may consider that an abnormality occurs when the object on which the temperature sensitive fire extinguisher 50 is installed moves in an arbitrary direction to the extent that it deviates from the allowable range.

The CO gas sensor 33 may consider that an abnormality occurs when a fire occurs and the concentration of carbon monoxide gas becomes higher than an allowable concentration.

The UV sensor 34 detects a wavelength of light, and when a wavelength of light estimated to be a flame is detected, it may be considered that an abnormal symptom occurs.

The ultrasonic sensor 35 may generate a sound of a specific band when the component to be observed is deformed due to high heat, and when the sound of the specific band is detected, it may be considered that an abnormal symptom occurs.

The ultrasonic sensor 35 may generate ultrasonic waves due to the occurrence of an arc or corona fire precursor phenomenon in the component to be observed, and if they are large enough to exceed the allowable range, it may be considered that an abnormal symptom occurs.

The processing unit 120 may receive data from each of the sensors described above and calculate a fire sign based on the input data.

The output unit 130 may output an operation signal for operating the trigger 40 when the processing unit 120 determines that there is a sign of fire.

The operation signal may operate a trigger 40 and the trigger 40 may heat a temperature sensor 52 in the temperature sensitive fire extinguisher 50 to a high temperature in a very short time.

Accordingly, in the temperature sensitive fire extinguisher 50, the temperature sensing unit 52 detects the reaction temperature value and spreads the extinguishing agent to quickly respond to the initial fire.

In particular, the device for forcing the operation of the temperature sensitive fire extinguisher according to the embodiment of the invention may actively, quickly and effectively suppress the initial fire before the fire spreads significantly by allowing the temperature sensing unit 52 to detect the reaction temperature value immediately in near real time without waiting for the ambient temperature of the temperature sensing unit 52 to reach the reaction temperature value when a fire sign occurs.

In addition, the output unit 130 may further include a communication port 36 to communicate with a remote control unit 60.

The communication port 36 may be connected to a local area network, an internet network, a wireless communication network, etc., and thereby information obtained from the various sensing devices described above may be transmitted to the manager, and the manager can watch the fire site or component through the device for forcing the operation of the temperature sensitive fire extinguisher according to the embodiment of the invention, and can know the current situation more accurately.

In addition, an operation signal may be artificially generated by the manager, and the operation signal may be transmitted to the device for forcing the operation of the temperature sensitive fire extinguisher according to the embodiment of the invention through the communication port 36.

The device for forcing the operation of the temperature sensitive fire extinguisher according to the embodiment of the invention may force the trigger 40 to operate by inputting an operation signal to the processing unit 120 so that the remote control unit 60 operates the trigger 40.

In other words, the manager can grasp the situation of the object to be observed in the remote management room, and even if no actual fire has occurred, for example, no flame or no smoke, generate an operation signal when the possibility of a fire is estimated based on fire data to forcibly operate the trigger 40.

The fire data may be data recording the temperature information at which a fire occurs for each observation object or for each component. Therefore, the device for forcing the operation of the temperature sensitive fire extinguisher according to the embodiment of the invention may set an ignition point temperature value for each component constituting the facility even if one facility is observed.

That is, when there are a plurality of components in one observation target facility, the possibility of fire may be estimated based on the fire data recorded with the ignition point temperature value for each component, and thus the device for forcing the operation of the temperature sensitive fire extinguisher according to the embodiment of the invention may contribute to the prevention of fire accidents.

The device for forcing the operation of the temperature sensitive fire extinguisher according to the embodiment of the invention may be installed so that the installation location may be installed to face a component that generates heat by being installed, for example, on a door, an inner wall, a column, or the like of an object to be observed.

In addition, the device for forcing the operation of the temperature sensitive fire extinguisher according to the embodiment of the invention may be configured to include a body box 10 and a swing body 20.

In the body box 10, various sensing devices described above may be installed, for example, any one or a plurality of ones selected from the electromagnetic wave sensor 31, the three-axis acceleration sensor 32, the CO gas sensor 33, the UV sensor 34, and the ultrasonic sensor 35 may be installed.

The swing body 20 may be installed in the body box 10 and adjusted and fixed to face the object to be observed.

More specifically, the swing body 20 may be installed on a fixing bolt 24 fastened to the body box 10, and may rotate when the fixing bolt 24 is loosely tightened, and may be fixed to the body box 10 by tightly tightening the fixing bolt 24.

That is, the manager may rotate the swing body 20 to a desired posture and tighten the fixing bolt 24 to fix the swing body 20 to maintain the desired posture.

The desired posture may be a posture in which the video camera 21 or the thermal imaging camera 22 faces a direction in which the component to be observed is photographed. Accordingly, even if there are many components to be observed, the posture of the swing body 20 may be set by specifying a component having a high fire possibility or a low ignition point temperature among many components.

As described above, the swing body 20 may be provided with the video camera 21 and the thermal imaging camera 22.

The video camera 21 is a device for obtaining image data by photographing an object to be observed. When a fire occurs and a flame is generated or smoke rises, the fire may be recognized through the image data obtained through the video camera 21.

The thermal imaging camera 22 may measure the temperature of the object to be observed. That is, when the temperature value of a specific component in the observed object reaches or becomes higher than the set temperature value, it can be recognized as a fire or it can be inferred that a fire is likely to occur.

Therefore, in the device for forcing the operation of the temperature sensitive fire extinguisher according to the embodiment of the invention, the components having a low ignition point temperature even in one facility can be concentrated and observed, and even if the overall temperature of the object being observed, for example the ambient temperature, is not a dangerous temperature, when the temperature of a particular component has reached or is likely to reach the ignition point temperature, this fact may be recognized more quickly, and therefore, it is possible to take action before an actual fire occurs or to quickly respond to extinguish the initial fire even if an actual fire occurs.

In addition, the device for forcing the operation of the temperature sensitive fire extinguisher according to the embodiment of the invention may be configured to further include a light 23.

The light 23 may be installed on one side of the video camera 21 or the thermal imaging camera 22, thereby increasing the video image quality by allowing the light 23 to illuminate the object to be observed.

A video image may be an important basis for judging whether a fire has occurred, and a high-quality video image may increase the accuracy of judgment.

Although the embodiments of the invention have been described with reference to the accompanying drawings, those skilled in the art to which the invention pertains will understand that the invention may be embodied in other specific forms without changing the technical spirit or essential features thereof.

Therefore, the embodiments described above are to be understood as illustrative and not restrictive in all respects, and the scope of the invention is indicated by the following claims, and all changes or modifications derived from the meaning and scope of the claims and their equivalents should be construed as being included in the scope of the invention.

The device for forcing the operation of the temperature sensitive fire extinguisher according to an embodiment of the invention may be used to forcibly operate the temperature sensitive fire extinguisher when the temperature of the object to be observed reaches the reaction temperature value set by the user to prevent the spread of fire.

### Reference Sign List

| | |
|---|---|
| 10: body box | 20: swing body |
| 21: video camera | 22: thermal imaging camera |
| 23: light | 24: fixing bolt |
| 31: electromagnetic wave sensor | 32: three-axis acceleration sensor |
| 33: CO gas sensor | 34: UV sensor |
| 35: ultrasonic sensor | 36: communication port |
| 40: trigger | 50: diffusion fire extinguisher |
| 52: temperature sensing unit | 60: remote control unit |
| 110: input unit | 120: processing unit |
| 130: output unit | |

What is claimed is:

1. A device for forcing the operation of a temperature sensitive fire extinguisher comprising:
an input unit configured to receive data from any one of a video camera, a thermal imaging camera, an electromagnetic wave sensor, a three-axis acceleration sensor, a CO gas sensor, a UV sensor, and an ultrasonic sensor;
a processing unit configured to calculate a fire occurrence sign based on the data; and
an output unit configured to heat a temperature sensing unit of a temperature sensitive fire extinguisher by operating a trigger when the processing unit determines that there is a sign of fire.

2. The device according to claim 1,
wherein the output unit further includes a communication port allowing communication with a remote control unit; and
wherein the remote control unit forcibly operates the trigger by forcibly inputting an operation signal to the processing unit to operate the trigger.

3. The device according to claim 1, further comprising:
a body box in which any one or a plurality of selected ones of the electromagnetic wave sensor, the three-axis acceleration sensor, the CO gas sensor, the ultraviolet sensor, and the UV sensor are installed; and
a swing body installed in the body box and adjusted and fixed to face the object to be observed, and installed with the video camera and the thermal imaging camera so that the video camera and the thermal imaging camera photograph the object to be observed.

4. The device according to claim 3, further comprising:
a light installed on one side of the video camera or the thermal imaging camera, thereby increasing the video image quality by allowing the light to illuminate the object to be observed.
